(19) United States
(12) Patent Application Publication
(10) Pub. No.: US 2006/0092768 A1
(43) Pub. Date: May 4, 2006

(54) Time zone displays using circular timing elements

(76) Inventor: Theodore James Demas, Aspen, CO (US)

Correspondence Address: LATHROP & GAGE LC, 4845 PEARL EAST CIRCLE, SUITE 300, BOULDER, CO, 80301, US

(21) Appl. No.: 11/128,963

(22) Filed: May 13, 2005

Related U.S. Application Data
(63) Continuation-in-part of application No. 10/978,066, filed on Oct. 30, 2004.
(63) Continuation-in-part of application No. 11/071,269, filed on Mar. 3, 2005.

(51) Int. Cl. G04B 19/22

(52) U.S. Cl. 368/21

(57) ABSTRACT

A clock display includes at least seven circular timing elements, each timing element configured to indicate time in a time zone.

### CROSS-REFERENCE TO RELATED APPLICATIONS

This application is a continuation-in-part of commonly-owned and copending U.S. patent application Ser. No. 10/978,066, filed 30 Oct. 2004, and is also a continuation-in-part of commonly-owned and copending U.S. patent application Ser. No. 11/071,269, filed 3 Mar. 2005. Both of the above mentioned applications are incorporated herein by reference.

### BACKGROUND

A traditional analog clock face uses a small hour hand, a larger minute hand, and, optionally, a thinner hand pivoting about a center; these hands point towards positions around a periphery of the clock to indicate hours, minutes and, optionally, seconds of current time. Numerals and/or tick marks are optionally included as visual references to help a viewer determine the position of the hands. While widely used, the traditional analog clock face is not easily understood at an intuitive level. For example, some children find it difficult to learn because (a) the hour hand carries the most significant information, and yet is the smallest of the hands, and (b) the minute hand may periodically obstruct visibility of the hour hand, making hour of day hard to determine.

### SUMMARY

A clock display includes at least seven circular timing elements, each timing element configured to indicate time in a time zone.

### BRIEF DESCRIPTION OF DRAWINGS

FIG. 1 shows one embodiment of a clock display with circular timing elements.

FIG. 2 shows one embodiment of a clock display with circular timing elements.

FIG. 2A illustrates physical appearance of the clock display of FIG. 2, in an illustrative example.

FIG. 3 shows one embodiment of a clock display with circular timing elements and locating elements.

FIG. 3A is an enlarged view of marked area A of FIG. 3.

FIG. 3B is a further enlarged view of marked area B of FIG. 3A.

FIG. 4 shows one embodiment of a clock display with circular timing elements, locating elements and numeric indicators.

FIG. 5A shows one embodiment of a clock display with circular timing elements, numerals and locating elements.

FIG. 5B is an enlarged view of the center element of the clock display of FIG. 5A, in accord with one embodiment.

FIG. 6 shows one embodiment of a clock display with circular timing elements and locating elements.

FIG. 7A shows one embodiment of a clock display with circular timing elements, in accord with one embodiment.

FIG. 7B shows an inner perimeter, a center element and circular timing elements of the clock display of FIG. 7A, in accord with one embodiment.

FIG. 7C shows an inner perimeter and exemplary circular timing elements of the clock display of FIG. 7A, in accord with one embodiment.

FIG. 8A shows one embodiment of a clock display with circular timing elements, and an hour hand, a minute hand and a third hand.

FIG. 8B shows one embodiment of a clock display with circular timing elements, and an hour hand and a minute hand.

FIG. 9 illustrates one watch with a clock display including circular timing elements.

FIG. 10 illustrates one watch with a clock display including circular timing elements.

FIG. 11 illustrates, in a perspective view, one watch with a clock display including circular timing elements.

FIG. 12 illustrates one watch with a clock display including circular timing elements.

FIG. 13 illustrates one watch with a clock display including circular timing elements.

FIG. 14 illustrates one watch with a clock display including circular timing elements.

FIG. 15 is a system embodiment for operating a clock display with circular timing elements.

FIG. 16 shows one process embodiment for displaying time using circular timing elements.

FIG. 17 shows a timing process that may be utilized to generate output for a clock display with circular timing elements.

FIG. 18 shows one embodiment of a clock display 100(13) with circular timing elements.

### DETAILED DESCRIPTION OF DRAWINGS

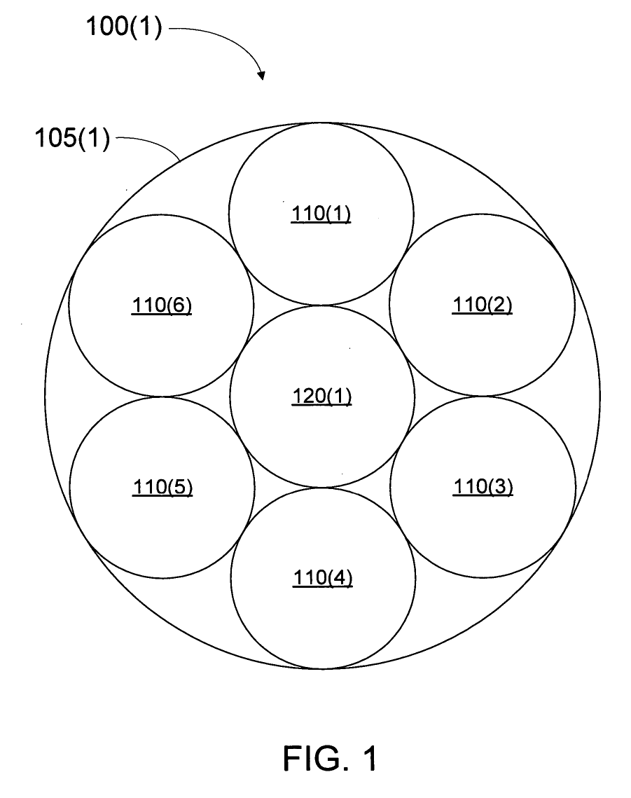

FIG. 1 shows one embodiment of a clock display 100(1) with circular timing elements 110(1)-110(6). Clock display 100(1) also includes a central element 120(1) that, for example, may be centrally disposed between elements 110(1)-110(6). Elements 110 and 120 may form similarly sized circles such that elements 110(1)-110(6) form a hexagonal pattern, with each element 110 being tangential to two other elements 110 and to central element 120, as shown. In the illustrated embodiment, elements 110(1), 110(4) and 120(1) align vertically.

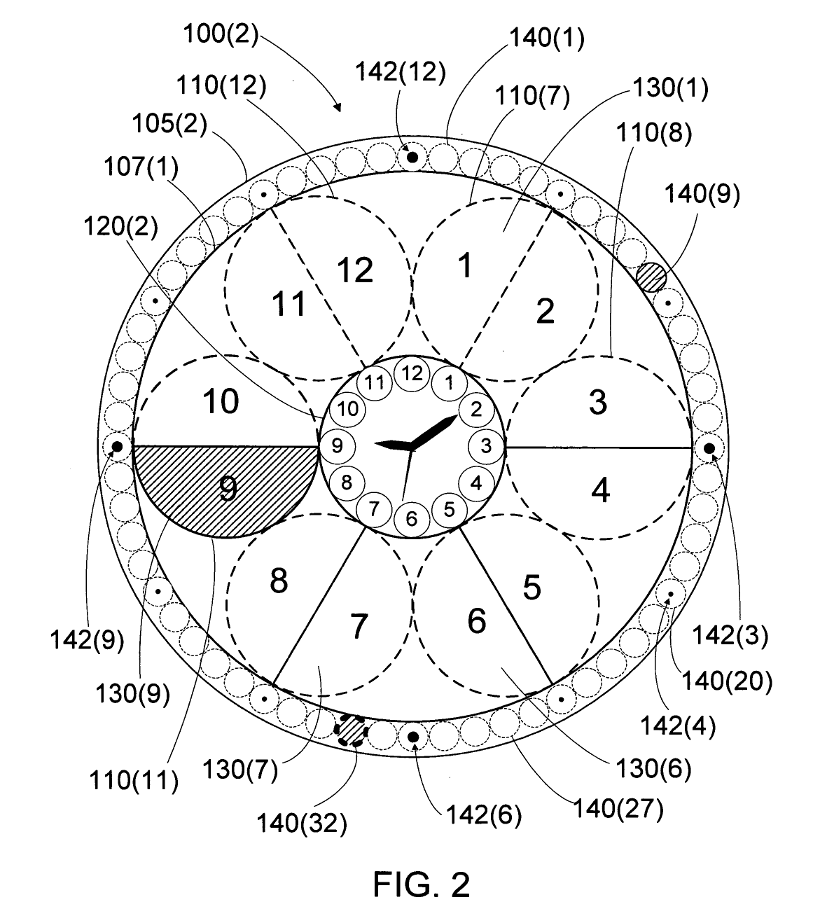

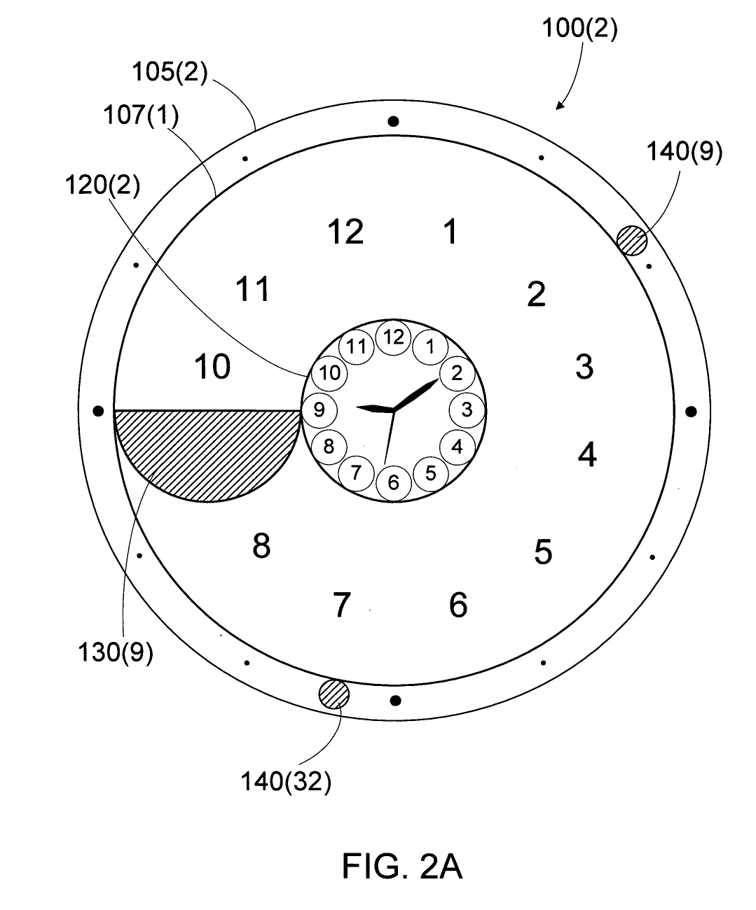

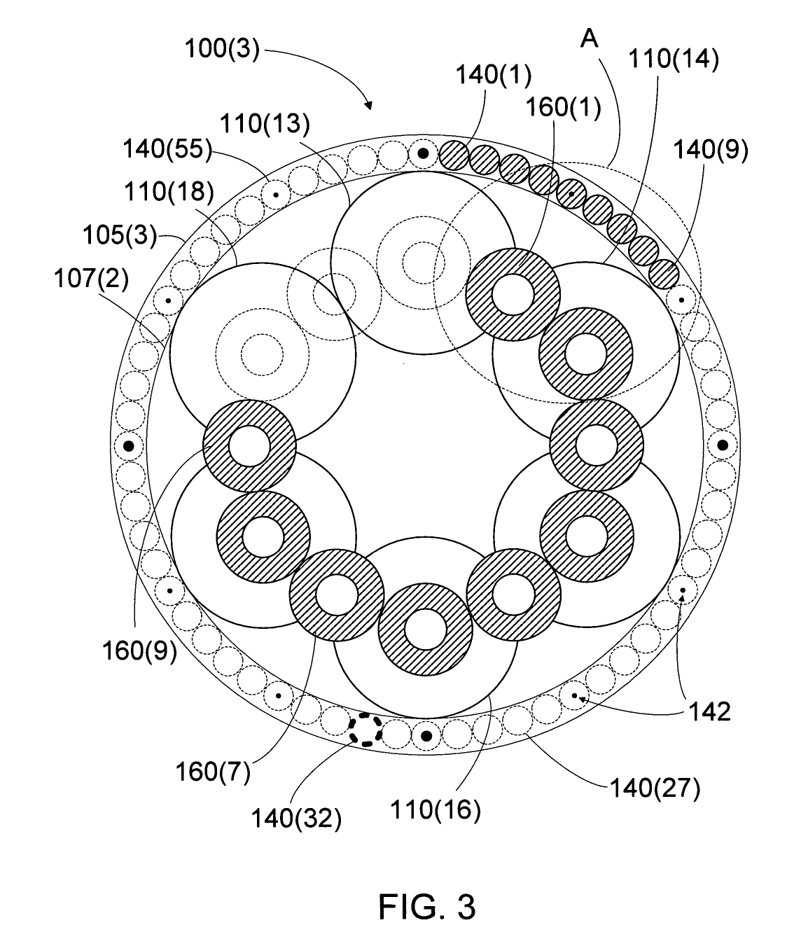

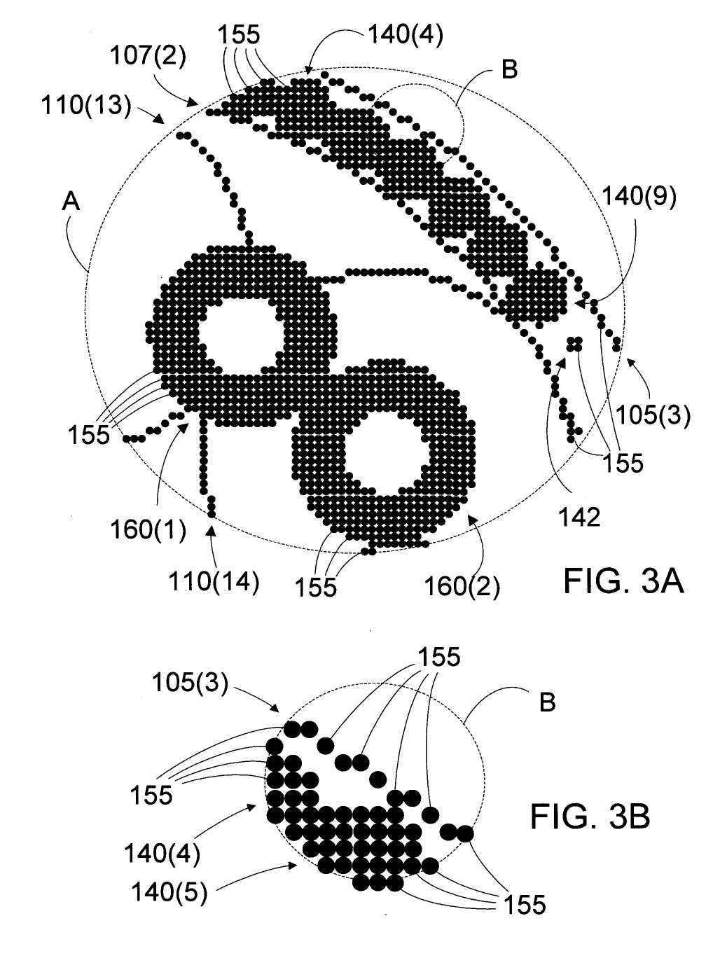

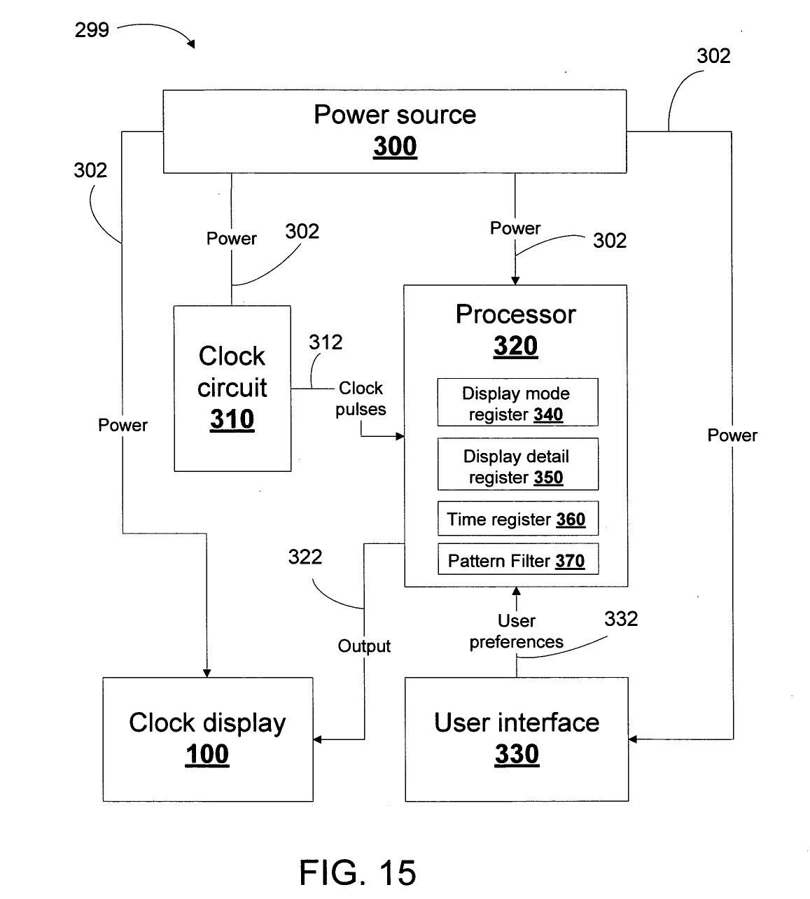

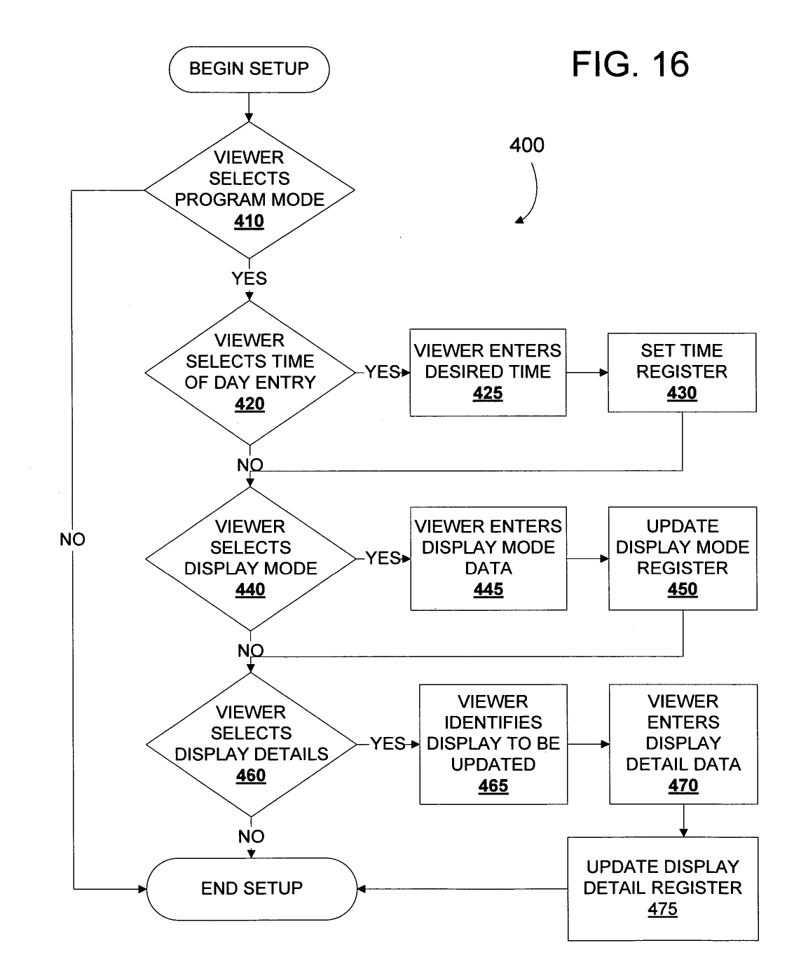

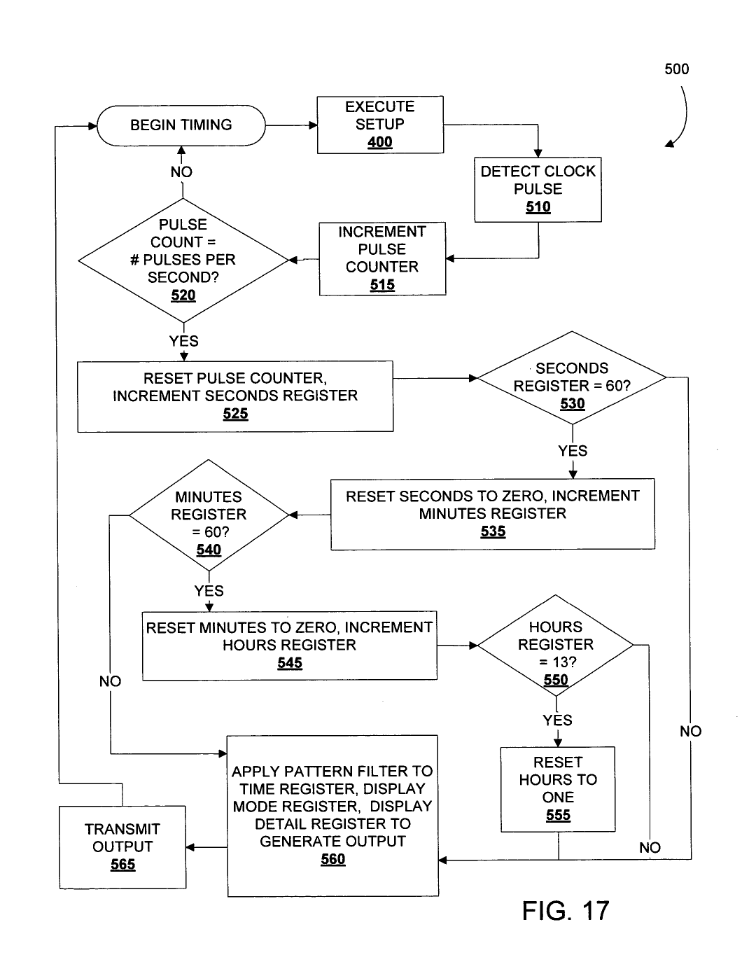

Elements 110(1)-110(6), 120(1) may be formed by electronic display devices (e.g., liquid crystal displays (LCDs), light-emitting devices (e.g., discrete lamps or light emitting diodes (LEDs)) and metal structure (e.g., aluminum, brass, gold). In one embodiment, and as described in more detail below, each such circular timing element is formed, at least in part, by activated display devices within an array of display devices, as described in connection with FIG. 2A, FIG. 3, FIG. 3A, and FIG. 3B. An array of display devices may be under control of a processor, such as described in connection with FIG. 15, FIG. 16 and FIG. 17.

With further regard to FIG. 1, a perimeter 105(1) illustratively surrounds elements 110(1)-110(6) to provide clock display 100(1) with a circular boundary. Perimeter 105(1) may be part of a mechanical edge or structure of clock display 100(1).

The size, shape and/or orientation of circular timing elements 110, 120 may vary without departing from the scope hereof. For example, visual appearance of certain circular timing elements may be selectively highlighted (hereafter, “activated”) or may be otherwise altered to indicate time. For example, if an array of LEDs forms one or more circular timing elements, a subset of the LEDs may be activated in a selected pattern or shape to indicate time.

In another example, elements 110(1)-110(6), 120(1) may be identically sized, as shown in FIG. 1, or may be differently sized. Geometrical attributes (e.g., size, diameter, proximity) of circular timing elements may be determined by simultaneously activated display elements even if these display elements are not simultaneously activated to indicate time. For example, each of elements 110(1)-110(6) in FIG. 1 is shown with identical size and diameter, and each element 110(1)-110(6) is tangential to two other elements 110(1)-110(6); but when indicating time, only a subset of elements 110(1)-110(6) may be simultaneously activated (such as for example shown and illustrated in connection with FIG. 2A).

In another example, the shape of circular timing elements 110 may contact one another, as shown in FIG. 1, or they may be similarly distributed but not in contact; alternatively they may overlap one another. In another example, the orientation of elements 110 may be rotated—relative to the arrangement shown in FIG. 1—such that two elements 110 and central element 120 align horizontally instead of vertically (i.e., an arrangement of elements 110 may be rotated by 30° with respect to the arrangement of FIG. 1). In still another example, clock display 100(1) does not include a perimeter 105 and/or central element 120; it may however include additional features that visually divide clock display 100(1) into ring-shaped sections. In another example, each element 110 and/or 120 may consist of segments, or may contain additional elements. Clock display 100(1) may also include additional circular timing elements.

Accordingly, this description describes exemplary embodiments of a clock display 100 with circular timing elements. In the figures, therefore, clock display 100 and elements 105, 110, 120 are for example denoted with numerals in parentheses (e.g., 100(2)) to indicate similar but not necessarily identical instances of a clock display or circular timing element. At times, for purposes of illustration, only representative features are labeled within the figures.

FIG. 2 shows one embodiment of a clock display 100(2) with circular timing elements 110(7)-110(12), 120(2) and 140(1)-140(60). In the illustrated embodiment, elements 110(7)-110(12) are arranged such that elements 110(8)-110(11) align horizontally with a central element 120(2). Elements 110(7)-110(12) illustratively form twelve semicircles 130(1)-130(12), as shown. Each such semicircle indicates a specific clock hour, e.g., “1,” “2,” and so on.

In clock display 100(2), an inner perimeter 107(1) may encircle elements 110(7)-110(12), as shown. Clock display 100(2) may further include sixty circular timing elements 140(1)-140(60) arranged between inner perimeter 107(1) and an outer perimeter 105(2). Perimeters 107(1) and 105(2) may, for example, be part of a mechanical edge or structure of clock display 100(2). A series of locating elements 142(1)-142(12) are positioned, for example, within every fifth element 140 as a visual aid for identifying each timing element 140 by number (e.g., locating element 142(4) with element 140(12)). To help a viewer identify elements 140, locating elements 142(3), 142(6), 142(9) and 142(12) may be larger than other elements 142.

As above, elements 110(7)-110(12), 120(2), 130(1)-130(12), and 140(1)-140(60) may be formed by electronic display devices (e.g., LCDs) and/or light-emitting devices (e.g., an array of LEDs) and metal structure (e.g., aluminum, brass, gold). In one embodiment, and as described in more detail below, each such circular timing element is formed, at least in part, by an array of display devices under control of a processor, such as described in connection with FIG. 15, FIG. 16 and FIG. 17.

Accordingly, display devices of semicircles 130(1)-130(12) and timing elements 140(1)-140(60) may be “activated” to indicate a corresponding time, such as through operation by system 299, FIG. 15. In FIG. 2, display devices of semicircle 130(9) are illustratively “activated” to indicate a time including 9 o'clock, and element 140(9) is activated to indicate a time including nine minutes past an hour, so that a time represented by these activated elements is 9:09. Nonactivated semicircles 130 and elements 140 are shown in dashed outline and may not be readily visible by a viewer of clock display 100(2). Element 140(32), shown with a heavy dashed line, is illustrated as “activated” to indicate seconds of time. Thus, an exact time indicated by the activated semicircles 130 and elements 140 in FIG. 2 is 9:09:32. The clock hour “9” indicated in semicircle 130(9) may be electrically activated by display devices, or it may be physical text that is back-illuminated by display devices forming semi-circle 130(9).

FIG. 2A illustrates physical appearance of clock display 100(2), in an illustrative example. In FIG. 2A, nonactivated display devices and elements are not shown, for purposes of illustration. Activated display devices of semicircle 130(9) and elements 140(9) and 140(32) are, in this example, liquid crystal display (LCD) devices indicated by crosshatched lines. Numerals “1,” “2,” and so on may be visible, as shown, except for numeral “9” which may be obscured by activated display devices of semicircle 130(9).

Central element 120(2) may appear as an analog clock, as shown. The analog clock may be formed, for example, by display structure or an array of display devices; however in one embodiment, central element 120(2) is an analog clock that does not employ activatable display devices.

Display devices forming a circular timing element or locating element may be activated by one of several techniques, for example: (a) an LED illuminated against a darker background; (b) a colored LED against a differently-colored LED; (c) a darkened LCD segment against a lighter background; (d) individually addressable pixels of an electronic display (e.g., a cathode-ray tube based monitor, plasma display, active matrix display, or digital light processing display), (e) a time-varying intensity or color; or (f) a combination of (a), (b), (c), (d) and/or (e). In embodiments using arrays of display devices to form circular timing elements, the appearance of circular timing elements may define geometrical attributes of, for example, size, diameter and proximity, when all the display devices are simultaneously activated (even though to indicate time only a subset of such display elements may be simultaneously activated). Accordingly, such geometric attributes may illustratively “contact,” or be “tangential” to, other circular timing elements.

In one embodiment, to differentiate minutes from seconds, an element 140 activated to indicate minutes may appear relatively constant to a viewer while elements 140 activated to indicate seconds change relatively quickly (every second) and/or may blink or flash to impart a sense of transience to a viewer.

FIG. 3 shows one embodiment of a clock display 100(3) with circular timing elements 110(13)-110(18), 140(1)-140(60) and 160(1)-160(12), and locating elements 142(1)-142(12). In clock display 100(3), each element 160 forms an annular ring. Illustratively, elements 160(1)-160(9) are shown activated to indicate a time including 9 o'clock. In this example, nonactivated elements 160 are shown in dashed outline. Area A is discussed below and shown in FIG. 3A.

As in clock display 100(2), elements 140(1)-140(60) may be used to indicate both minutes and seconds. In FIG. 3, elements 140(1)-140(9) are illustratively activated to indicate a time including nine minutes past an hour, and element 140(32) is shown with heavy dashed line to show that it is momentarily activated, indicating a time including thirty-two seconds. Other elements 140 are shown in light dashed outline because, in this example, they are not activated. Thus, an exact time indicated by display 100(3) is 9:09:32. The selection of multiple elements indicating minutes and hours may thus convey an intuitive sense of cumulative time to a viewer (i.e., elements 160(1)-160(9) impart a sense of time elapsed since 12 o'clock, and elements 140(1)-140(9) impart a sense of time elapsed since 9:00).

Like the elements shown in FIG. 2, elements 110(13)-110(18), 120(2), 140(1)-140(60) and 160(1)-160(12), locating elements 142(1)-142(12) and perimeters 107(1) and/or 105(2) may be formed by electronic display devices (e.g., LCDs) and/or light-emitting devices (e.g., an array of LEDs) and metal structure (e.g., aluminum, brass, gold). In one embodiment, and as described in more detail below, each such circular timing element is formed, at least in part, by an array of display devices under control of a processor, such as described in connection with FIG. 15, FIG. 16 and FIG. 17. Perimeters 107(1) and/or 105(2) may be part of a mechanical edge or structure of clock display 100(2).

FIG. 3A is an enlarged view of area A of FIG. 3, showing all or part of elements 110(13), 110(14), 140(4)-140(9), 160(1), 160(2) and perimeters 105(3) and 107(2) formed by individually activatable display devices 155 under control of a processor, such as described in connection with FIG. 15, FIG. 16 and FIG. 17. Area B is discussed below and shown in FIG. 3B.

FIG. 3B is an enlarged view of area B of FIG. 3A, showing exemplary individually activatable display devices 155 forming portions of elements 140(5), 140(6) and perimeter 105(3). Display devices 155 may be individually activatable by a processor, as described in connection with FIG. 15, FIG. 16 and FIG. 17.

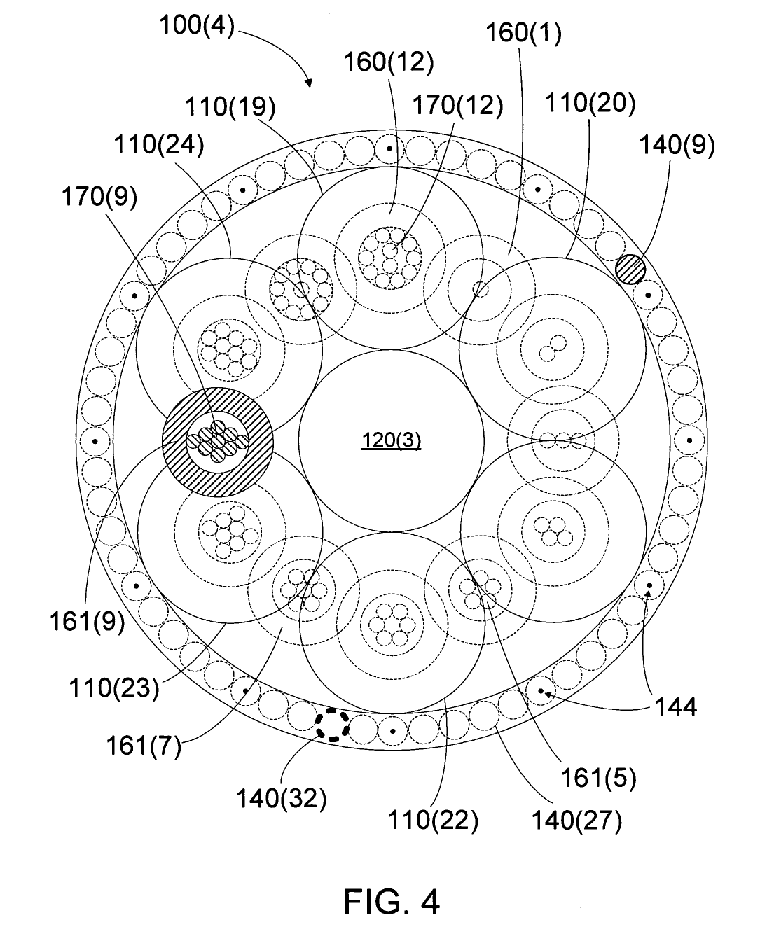

FIG. 4 shows one embodiment of a clock display 100(4) with circular timing elements 110(19)-110(24), 120(3), 140(1)-140(60) and 161(1)-161(12), locating elements 144, and numeric indicators 170(1)-170(12). In the exemplary illustration of clock display 100(4), elements that are not activated are shown in dashed outline; activated elements 140(9), 161(9) and 170(9) are shown with crosshatching; and activated element 140(32) is shown in a heavy dashed outline. As above, elements 110(19)-110(24), 140(1)-140(60) and 161(1)-161(12), locating elements 144, and numeric indicators 170(1)-170(12) may be constructed of display devices (e.g., display devices 155, FIG. 3A and FIG. 3B). Elements 161(1)-161(12) of clock display 100(4) are, in this example, larger than elements 160(1)-160(12) of clock display 100(3); correspondingly, elements 161(1)-161(12) overlap slightly. Numeric indicators 170 form circles, each circle indicating one hour. Thus, numeric indicator 170(9) forms nine circles and indicates a time including 9 o'clock in this example. Using circles as numerical substitutes may increase a viewer's association of circles with representation of time. In clock display 100(4), element 140(9) may be activated to indicate a time including nine minutes past an hour, for example. Element 140(32) is shown as a heavy dashed line to show that it is momentarily activated, in this example, to indicate a time including thirty-two seconds. Thus an exact time indicated by the illustratively activated circular timing elements of clock display 100(4) is 9:09:32.

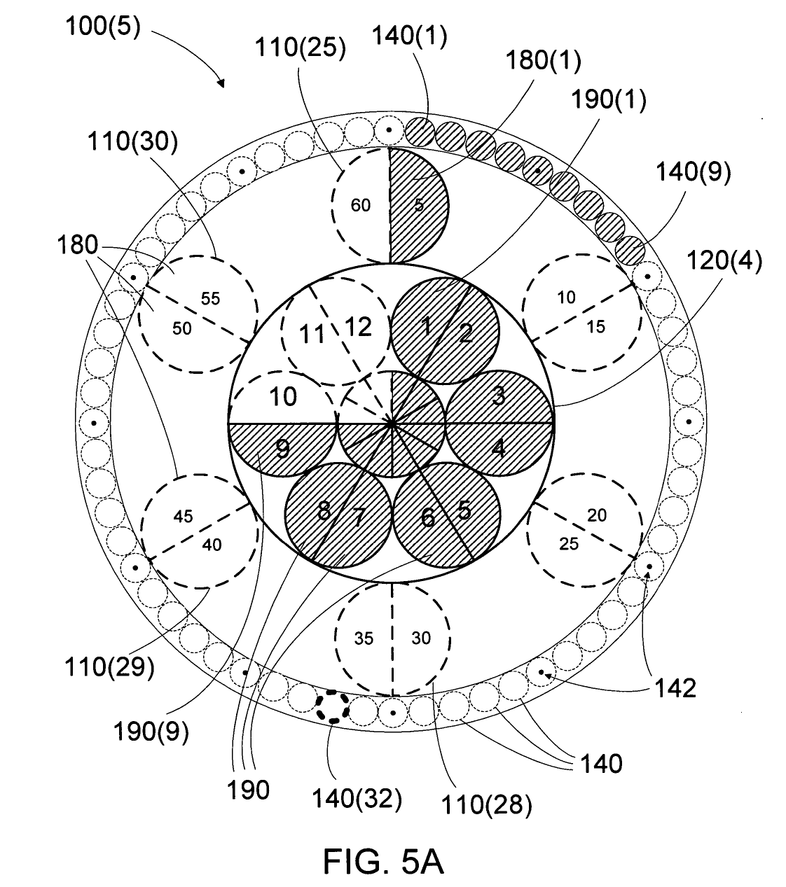

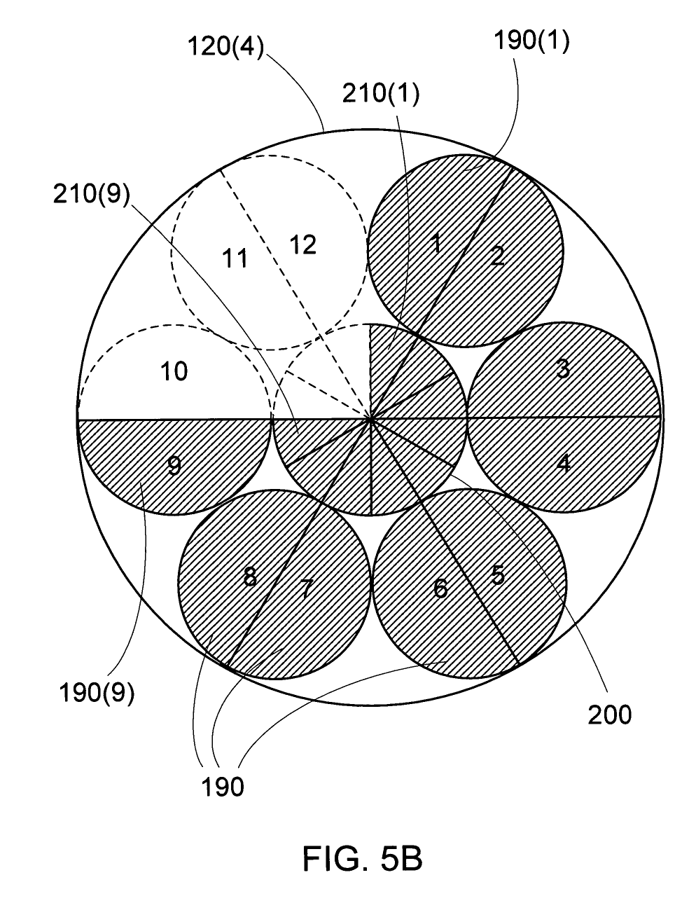

FIG. 5A shows one embodiment of a clock display 100(5) with circular timing elements 110(25)-110(30), 120(4), 140(1)-140(60) and locating elements 142. In illustrated operation of clock display 100(5), elements that are not activated are shown in dashed outline; activated elements 140(1)-140(9), 180(1) and 190(1)-190(9) are shown with crosshatching; and activated element 140(32) is shown in a heavy dashed outline. Like other embodiments, elements 110(25)-110(30), 120(4), 140(1)-140(60), 180(1)-180(12) and 190(1)-190(12) and locating elements 142 may be constructed with display devices (e.g., display devices 155, FIG. 3A and FIG. 3B).

In comparison to the clock displays of FIG. 1-FIG. 4, elements 110 of exemplary clock display 100(5) are illustratively smaller and do not touch one another, and central element 120 is illustratively larger; but the centers of elements 110 remain hexagonally arranged, as shown.

Elements 110(25)-110(30) are illustratively shown divided into semicircular elements 180(1)-180(12) that correspond to five-minute increments of time. Thus, for a time of nine minutes past an hour (as also indicated by activated elements 140(1)-140(9)), element 180(1) is activated to indicate a time including at least five minutes past an hour. Numerals “5,” “10,” “15” and so forth are shown within semicircles 180 in FIG. 5A, but may be omitted or replaced with other elements (e.g., numeric indicators 170 as shown in FIG. 4). Moreover, the use of five-minute increments within six elements 110 divided into twelve semicircles 180 is illustrative; other embodiments may utilize different numbers of elements and/or semicircles corresponding to different time increments. For example, another embodiment may utilize twelve circular elements, each such element corresponding to a five-minute time increment; each such element may be further divided into twenty-four semicircles, each such semicircle corresponding to a 2½-minute time increment.

Central element 120(4) in FIG. 5A is illustratively shown with semicircles 190(1)-190(12) corresponding to hours; display elements of 190(1)-190(9) are for example activated to indicate a time including 9 o'clock. In an illustrative example, elements 140(1)-140(9) are shown activated to indicate a time including nine minutes past an hour, and element 140(32) is shown as a heavy dashed line to show that it is momentarily activated to indicate a time including thirty-two seconds. Thus an exact time indicated by the activated circular elements of clock display 100(5) is 9:09:32. Center element 120(4) may be constructed as in FIG. 5B.

FIG. 5B shows an enlarged view of center element 120(4) of clock display 100(5), in accord with one embodiment. Semicircles 190 denote hours, with semicircles 190(1)-190(9) shown activated to illustrate a time including 9 o'clock. Numerals “1,” “2,” “3” and so forth are shown within elements 190 in FIG. 5A and 5B, but may be omitted or replaced with other elements (e.g., numeric indicators 170, FIG. 4). A circular timing element 200 is shown segmented into twelve segments 210(1)-210(12) that may also correspond to hours; segments 210(1)-210(9) are activated in correspondence with semicircles 190(1)-190(9), as shown. A viewer may intuitively grasp a sense of time more easily from viewing the combination of activated semicircles 190(1)-190(9) and segments 210(1)-210(9) than from viewing activated semicircles 190(1)-190(9) alone.

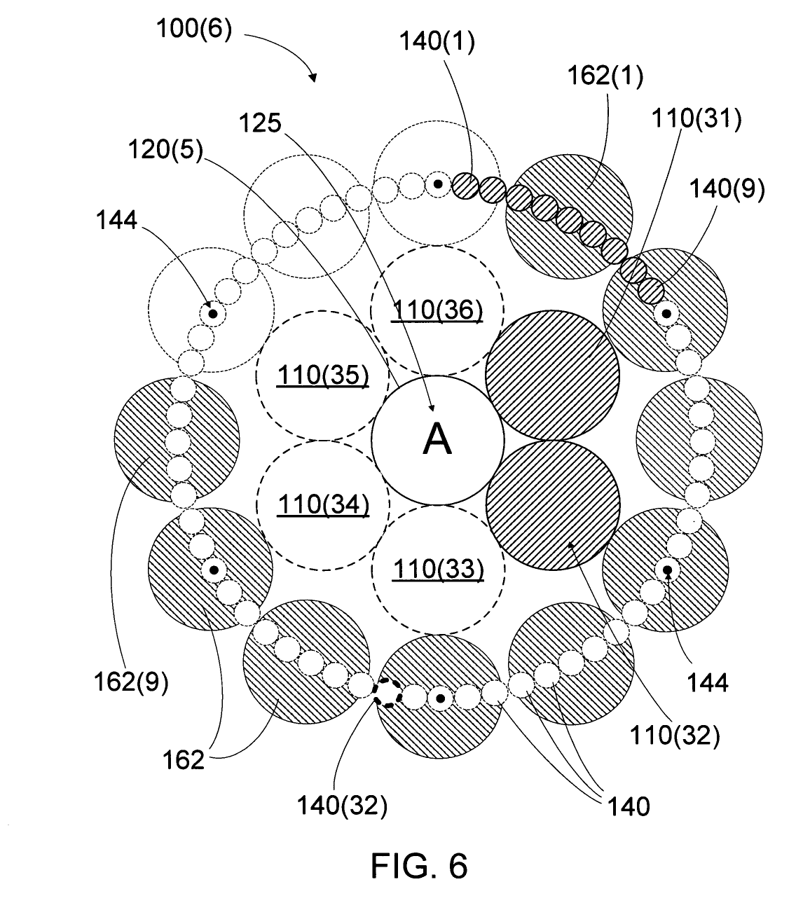

FIG. 6 shows one embodiment of a clock display 100(6) with circular timing elements 110(31)-110(36), 120(5), 140(1)-140(60) and 162(1)-162(12), and locating elements 144. In clock display 100(6), each element 162(1)-162(12) forms a circle. Elements 162(1)-162(9) are activated, in this example, to indicate a time including 9 o'clock, while nonactivated elements 162 are shown in dashed outline. In a manner similar to other embodiments, elements 110(31)-110(36), 120(5), 140(1)-140(60) and 162(1)-162(12), and locating elements 144 may be constructed with display devices (e.g., display devices 155, FIG. 3A and FIG. 3B).

In clock display 100(6), six elements 110(31)-110(36) are located closer to center element 120(5) as compared to elements 140 and 162. Each element 110 may represent a four-hour increment so that the six elements 110 provide a twenty-four hour clock. For example, elements 110(31) and 110(32) may be activated, indicating a time between 8 a.m. and noon, while nonactivated elements 110 are shown as unactivated in dashed outline. Center element 120(5) is shown with a letter A, indicating an a.m. time between midnight and noon; it alternates with a letter P (not shown) indicating a p.m. time between noon and midnight. Elements 140(1)-140(60) indicate both minutes and seconds; elements 140(1)-140(9) are activated, in this example, to indicate a time including nine minutes past an hour, and element 140(32) is shown as a heavy dashed line to show that it is momentarily activated to indicate a time including thirty-two seconds. Other unactivated elements 140 are illustratively indicated in light dashed outline. Thus, an exact time indicated by the activated circular timing elements of clock display 100(6) is 9:09:32 a.m. A locating element 144 may be located within every tenth element 140 as a visual aid for identifying a number corresponding to each element 140.

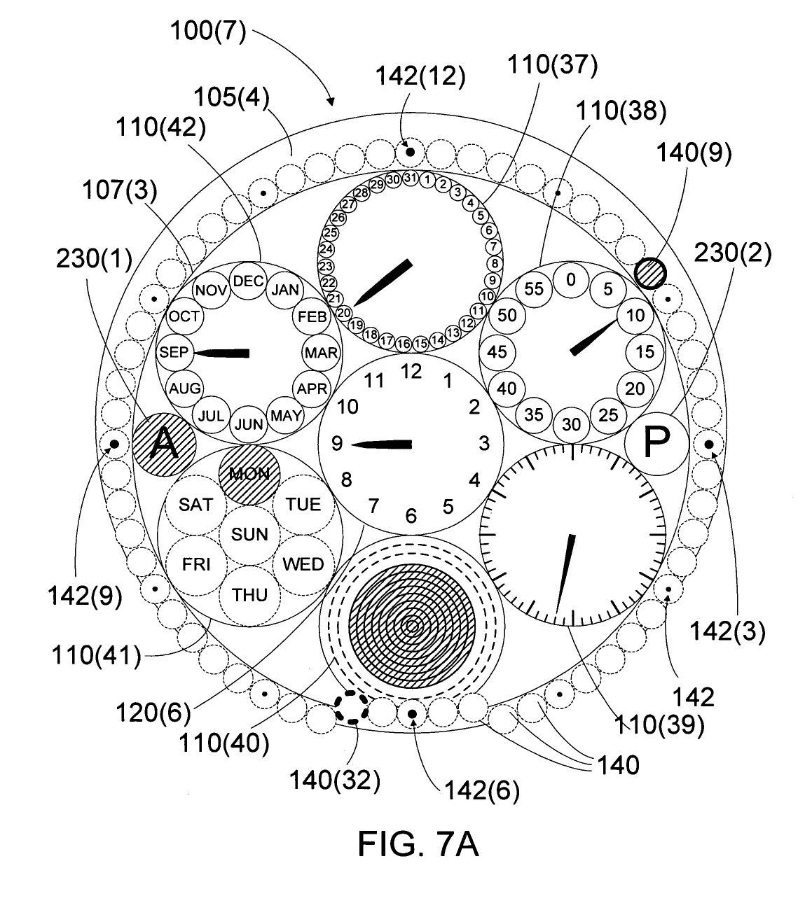

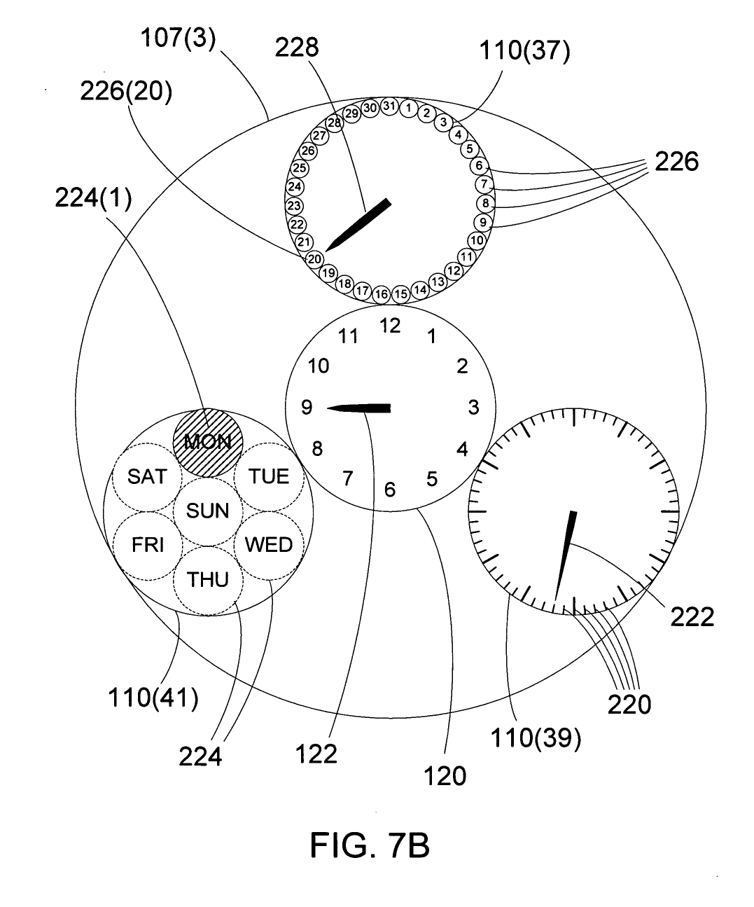

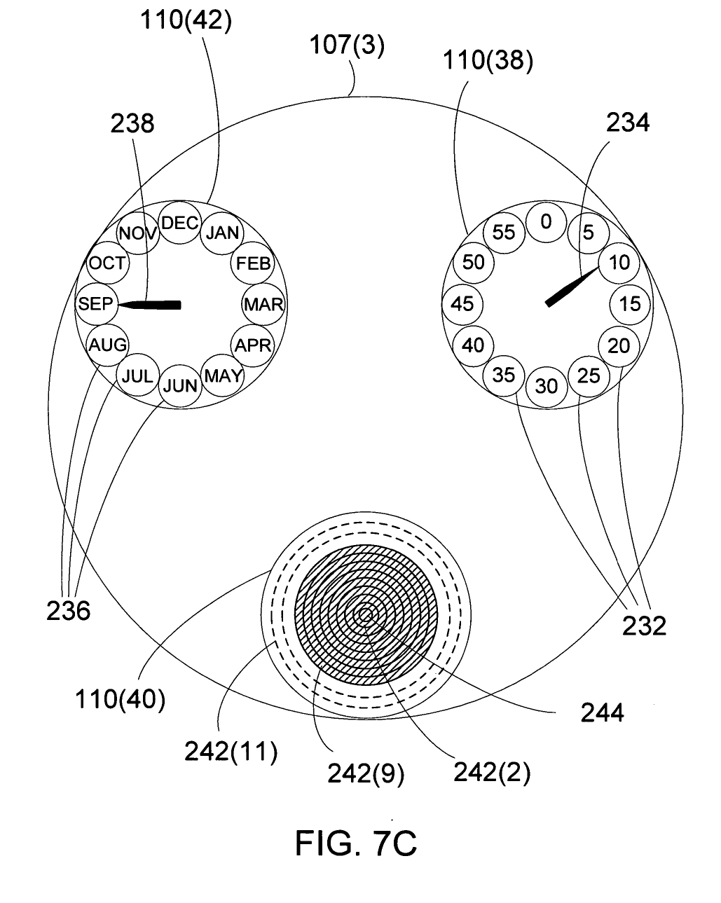

FIG. 7A, FIG. 7B and FIG. 7C show one embodiment of a clock display 100(7) with circular timing elements 110(37)-110(42), 120(6), 140(1)-140(60), 224(1)-224(7), 226(1)-226(31), 230(1) and 230(2), 232(1)-232(12), 236(1)-236(12), 242(2)-242(11) and 244, in accord with one embodiment. Only exemplary elements 110, 120, 140, 230 and locating elements 142 are labeled in FIG. 7A, for clarity of illustration. Elements 224, 226, 234, 238, 242 and 244 and certain other features not labeled in FIG. 7A are instead labeled in FIG. 7B and/or FIG. 7C. In a manner similar to other embodiments, elements 110(37)-110(42), 120(6), 140(1)-140(60), 224(1)-224(7), 226(1)-226(31), 230(1) and 230(2), 232(1)-232(12), 236(1)-236(12), 242(2)-242(11) and 244 may be constructed with display devices (e.g., display devices 155, FIG. 3A and FIG. 3B).

In clock display 100(7), an inner perimeter 107(3) encircles elements 110, as shown, and sixty circular elements 140(1)-140(60) are arranged between inner perimeter 107(3) and an outer perimeter 105(4). A locating element 142 may be located within every fifth element 140 as a visual aid for identifying a number corresponding to each element 140. As an additional aid, elements 142(3), 142(6), 142(9) and 142(12) may be larger than other elements 142. Elements 140 may further indicate both minutes and seconds. In FIG. 7A, element 140(9) is for example activated to indicate a time including nine minutes past an hour, and element 140(32) is shown in heavy dashed outline to show that it is momentarily activated to indicate a time including thirty-two seconds. Other elements 140 are shown in dashed outline as they are not activated in this example.

In clock display 100(7), center element 120 and circular elements 110(37), 110(38), 110(39) and 110(42) are dials that indicate days of a month, hours, five-minute intervals, seconds and months, respectively.

FIG. 7B shows inner perimeter 107(3), center element 120 and circular elements 110(37), 110(39) and 110(41) of clock display 100(7). Center element 120 forms a dial with a hand 122 that moves to indicate hours. Circular element 110(37) has circular elements 226(1)-226(31) to indicate days of a month. Illustratively, a hand 228 points to element 226(20) to indicate a 20th day. Circular element 110(39) forms a dial with a hand 222 that moves to indicate seconds; a viewer may use tick marks 220 to identify an exact location of hand 222. Circular element 110(41) contains seven circular elements 224(1)-224(7) that indicate days of a week; in FIG. 7A and FIG. 7B, element 224(1) is activated, in this example, to indicate a Monday, while other unactivated elements 224 are shown in dashed outline. Numerals indicating hours and days of a month, and letters indicating days of a week are shown within FIG. 7A and FIG. 7B but are not labeled, for clarity of illustration. Hands 122, 222 and 228 may be constructed with display devices (e.g., display devices 155, FIG. 3A and FIG. 3B) or with analog clock hands.

FIG. 7C shows inner perimeter 107(3) and circular elements 110(38), 110(40) and 110(42) of clock display 100(7). Circular element 110(38) is a dial with a hand 234 that moves among circular elements 232 to indicate five-minute intervals. Circular element 110(40) contains a center spot 244 and rings 242(2)-242(11) that indicate hours. Each of center spot 244 and rings 242(2)-242(11) may be activated to indicate a corresponding hour; thus each twelve hour cycle “fills” circular element 110(3) from center spot 244 to outermost ring 242(11). Circular element 110(42) is a dial with a hand 238 that moves among circular elements 236 to indicate months. Numerals indicating five-minute intervals, and letters indicating months are shown within FIG. 7A and FIG. 7C but are not labeled, for clarity of illustration. Hands 234 and 228 may be constructed with display devices (e.g., display devices 155, FIG. 3A and FIG. 3B) or with analog clock hands.

Thus, taking into account the selected elements and hand positions shown in FIG. 7A, a time and date indicated by example is 9:09:32 a.m. on Monday, September 20.

Clocks with circular timing features may thus also include dials with hands, as shown in FIG. 7A, FIG. 7B and FIG. 7C. Hands on a clock with circular timing features may also include circles to promote the identification of time with circles by a viewer.

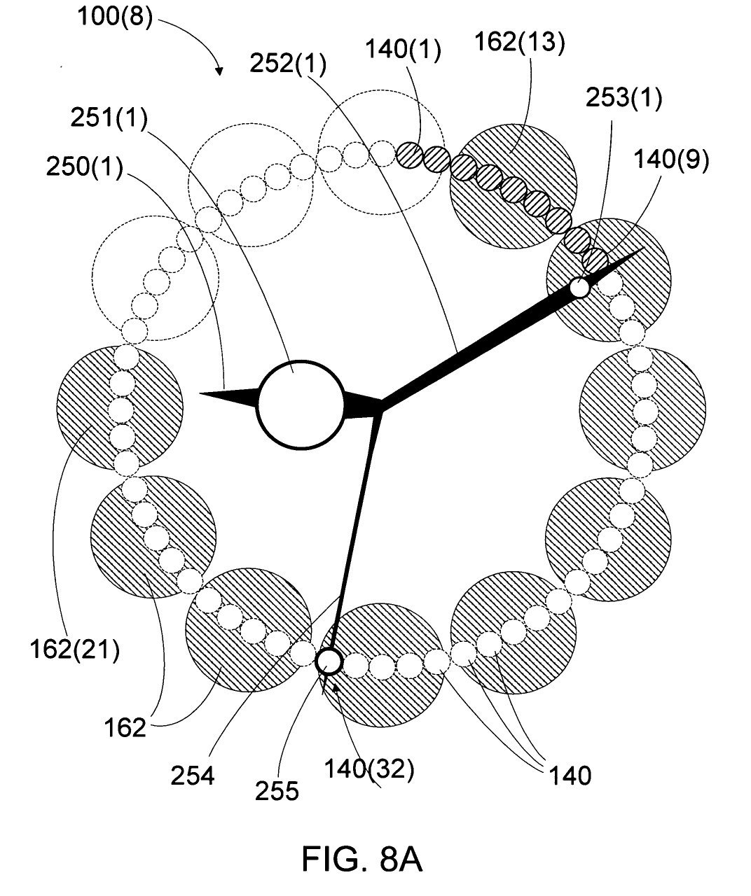

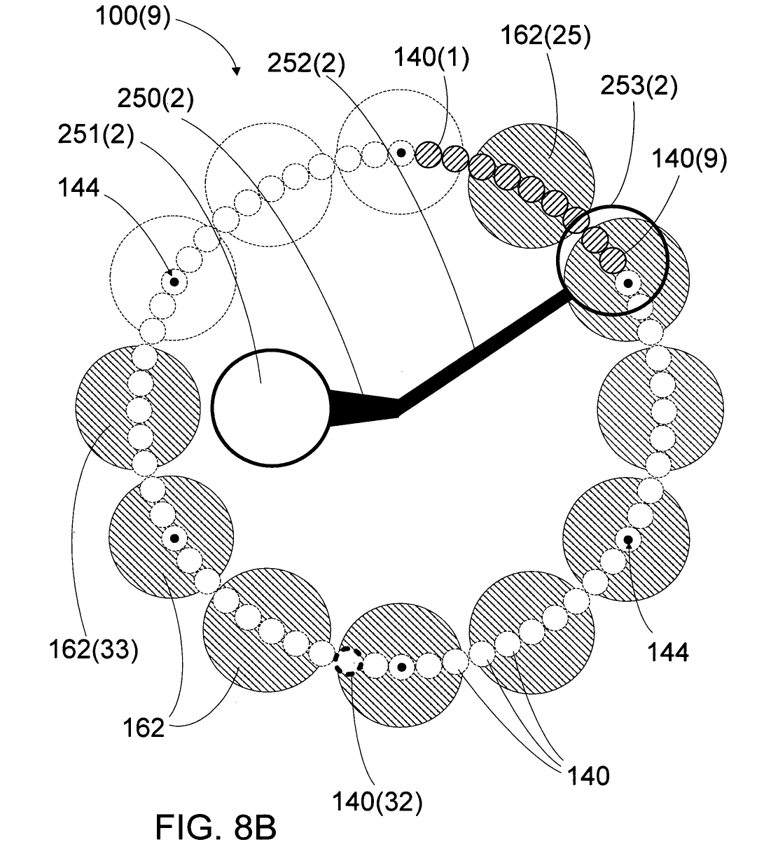

FIG. 8A shows one embodiment of a clock display 100(8) with circular timing elements 162(13)-162(24) and 140(1)-140(60), and with an hour hand 250(1), a minute hand 252(1) and a third hand 254. Hour hand 250(1) forms a circle 251(1), minute hand 252(1) forms a circle 253(1) and third hand 254 forms a circle 255, as shown. Hour hand 250(1), minute hand 252(1) and third hand 254 move like hands on an analog clock (i.e., in a continuous range, so that as seconds elapse, the minute hand moves towards the next minute and as minutes elapse, the hour hand moves towards the next hour). Elements 162(13)-162(21) may be activated, by example, to show a time including nine o'clock, and elements 140(1)-140(9) are activated, in this example, to show nine minutes elapsed since an hour. Elements 140 are not activated to indicate seconds in clock display 100(8); the position of third hand 254 and circle 255 are instead used to indicate seconds. Elements 162(13)-162(24) and 140(1)-140(60) may be constructed with display devices (e.g., display devices 155, FIG. 3A and FIG. 3B); hands 250(1), 252(1) and 254 may also be constructed with display devices (e.g., display devices 155, FIG. 3A and FIG. 3B) or with analog clock hands. An exact time indicated by the example activated circular elements and hands of clock display 100(8) is 9:09:32.

FIG. 8B shows one embodiment of a clock display 100(9) with circular timing elements 162(25)-162(36) and 140(1)-140(60), and with an hour hand 250(2) and a minute hand 252(2). Hour hand 250(2) forms a circle 251(2) and minute hand 252(2) forms a circle 253(2), as shown. Hour hand 250(2) and minute hand 252(2) move upon completion of full hours and minutes, respectively. Elements 162(25)-162(33) may be activated to show a time including nine o'clock, and elements 140(1)-140(9) may be activated to show nine minutes elapsed since an hour. Element 140(32) is shown as a heavy dashed line to indicate it is momentarily activated, in this example, indicating a time including thirty-two seconds. Elements 162(25)-162(36) and 140(1)-140(60) may be constructed with display devices (e.g., display devices 155, FIG. 3A and FIG. 3B); hands 250(2) and 252(2) may also be constructed with display devices (e.g., display devices 155, FIG. 3A and FIG. 3B) or with analog clock hands. An exact time indicated by the example activated circular elements and hands of clock display 100(9) is 9:09:32.

Certain embodiments of a clock display with circular timing elements may be programmable by a viewer, so that the display shows elements, colors, or light intensities preferred by the viewer. In one embodiment, a programmable clock display is programmed so that specific units of time measure (e.g., seconds, minutes, hours, days, months) appear on a viewer's choice of circular elements 110, or so that a viewer may select a style of numerals (e.g., Arabic or Roman numerals, or numeric indicators like numeric indicators 170 shown in FIG. 4).

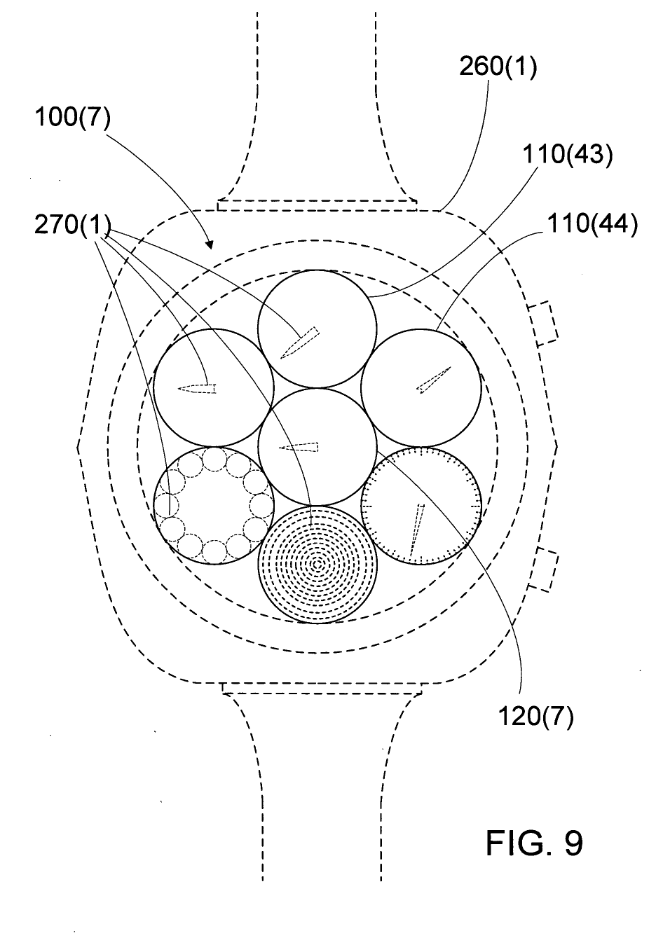

FIG. 9 illustrates one watch 260(1) with a clock display 100(7) including circular timing elements 110(43)-110(48) and 120(7). Clock display 100(7) may also include other elements 270(1) which may be, for example, hands, rings, numerals and/or other circular timing elements. Elements 110(43)-110(48), 120(7) and 270(1) may be constructed with display devices (e.g., display devices 155, FIG. 3A and FIG. 3B), for example.

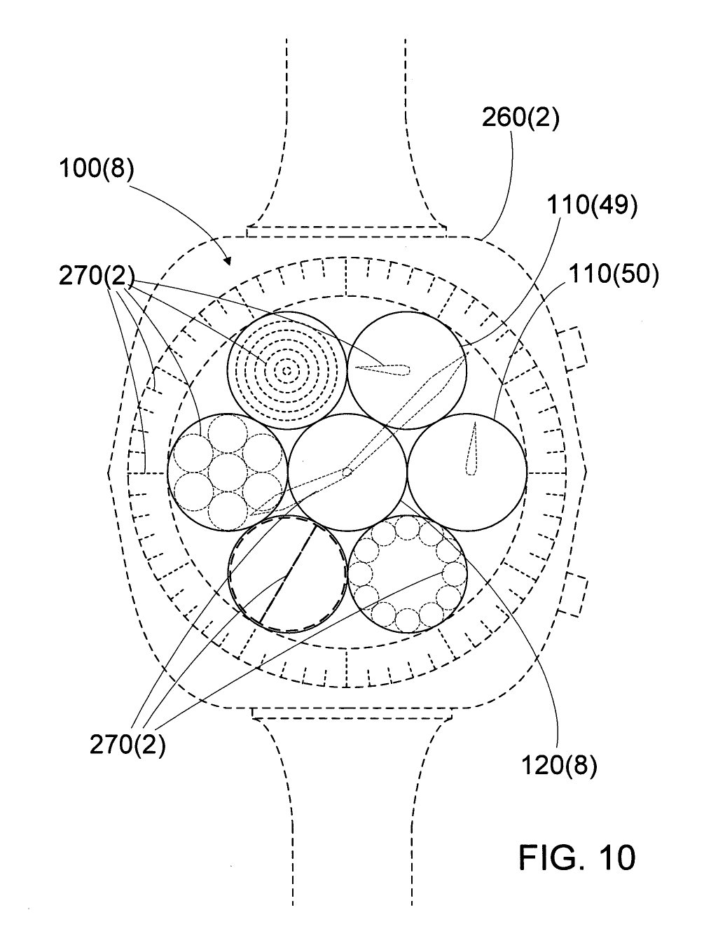

FIG. 10 illustrates one watch 260(2) with a clock display 100(8) including circular timing elements 110(49)-110(54) and 120(8). Clock display 100(8) may also include other elements 270(2) which may be, for example, hands, rings, numerals and/or other circular timing elements. Elements 110(49)-110(54), 120(8) and 270(2) may be constructed with display devices (e.g., display devices 155, FIG. 3A and FIG. 3B), for example.

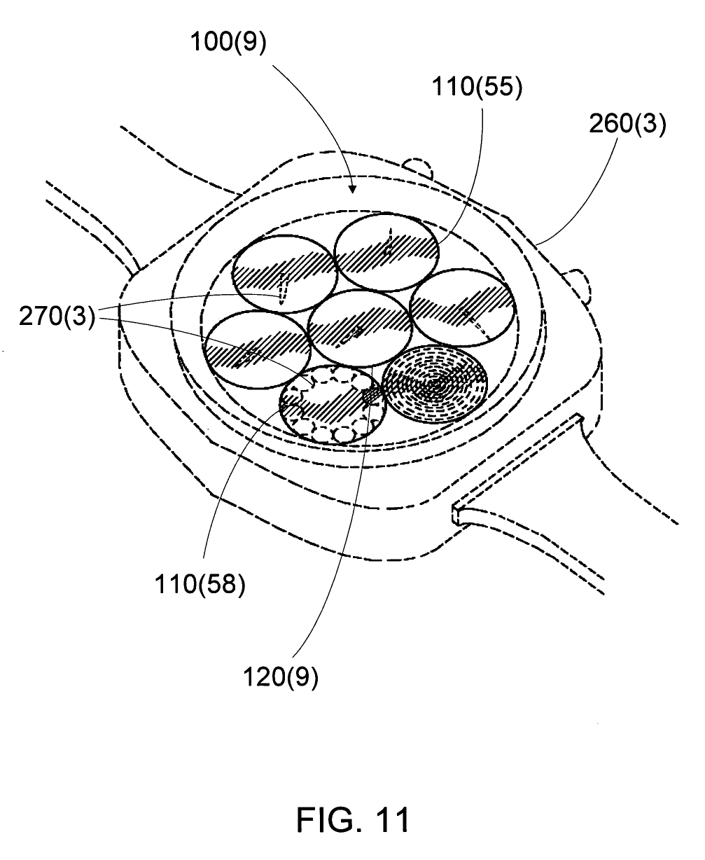

FIG. 11 illustrates, in a perspective view, one watch 260(3) with a clock display 100(9) including circular timing elements 110(55)-110(60) and 120(9). Clock display 100(9) may also include other elements 270(3) which may be, for example, hands, rings, numerals and/or other circular timing elements. Elements 110(55)-110(60), 120(9) and 270(3) may be constructed with display devices (e.g., display devices 155, FIG. 3A and FIG. 3B), for example.

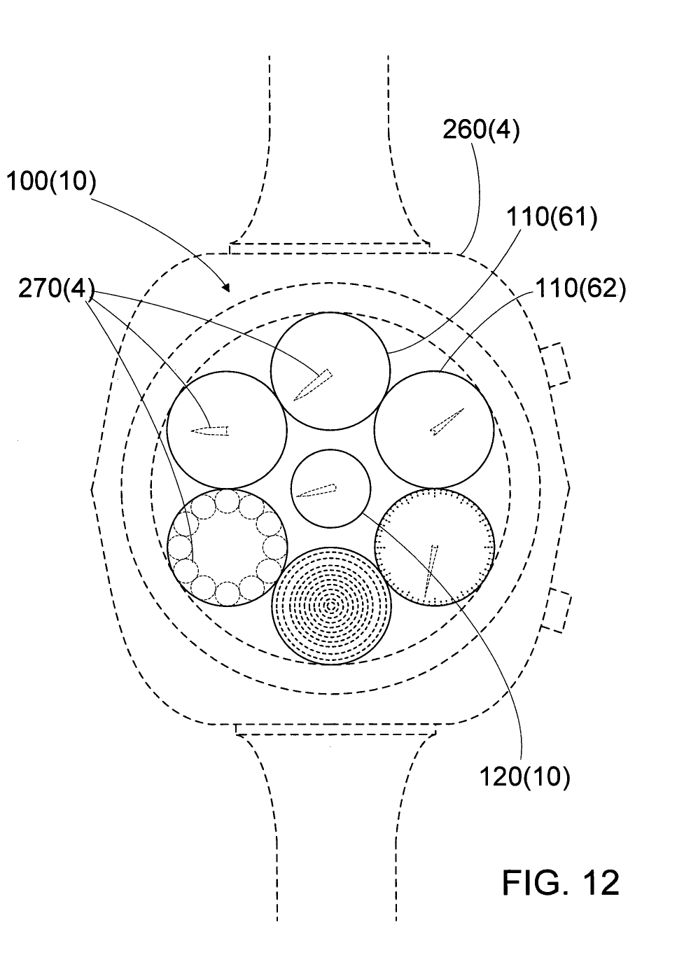

FIG. 12 illustrates one watch 260(4) with a clock display 100(10) including circular timing elements 110(61)-110(66) and 120(10). Clock display 100(10) may also include other elements 270(4) which may be, for example, hands, rings, numerals and/or other circular timing elements. Elements 110(61)-110(66), 120(10) and 270(4) may be constructed with display devices (e.g., display devices 155, FIG. 3A and FIG. 3B), for example.

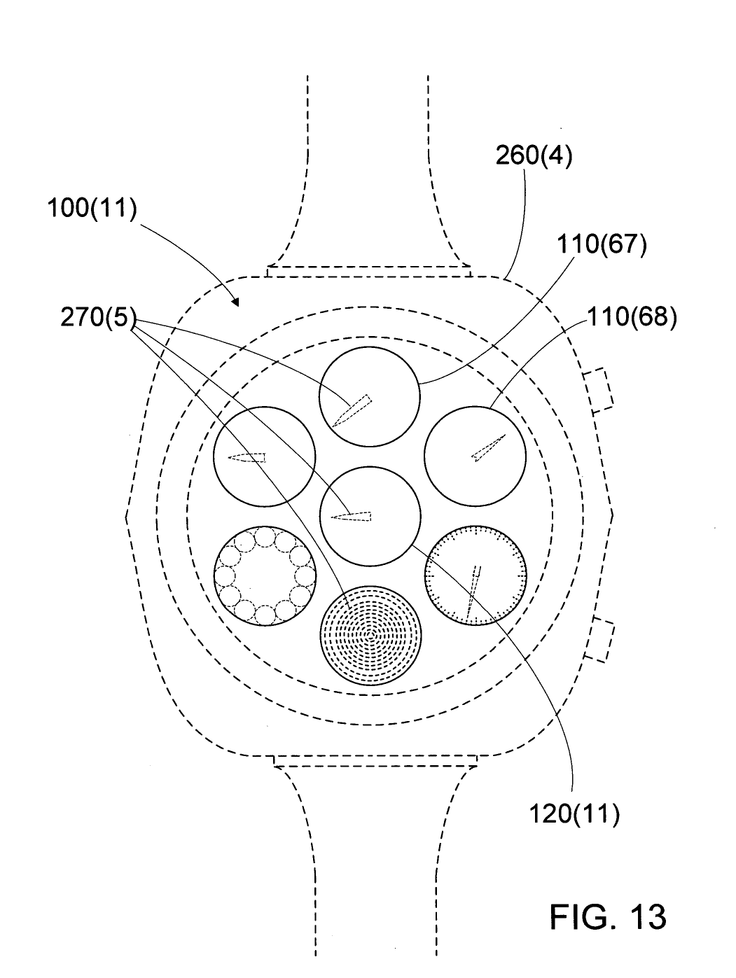

FIG. 13 illustrates one watch 260(4) with a clock display 100(11) including circular timing elements 110(67)-110(72) and 120(11). Clock display 100(11) may also include other elements 270(5) which may be, for example, hands, rings, numerals and/or other circular timing elements. Elements 110(67)-110(72), 120(11) and 270(5) may be constructed with display devices (e.g., display devices 155, FIG. 3A and FIG. 3B), for example.

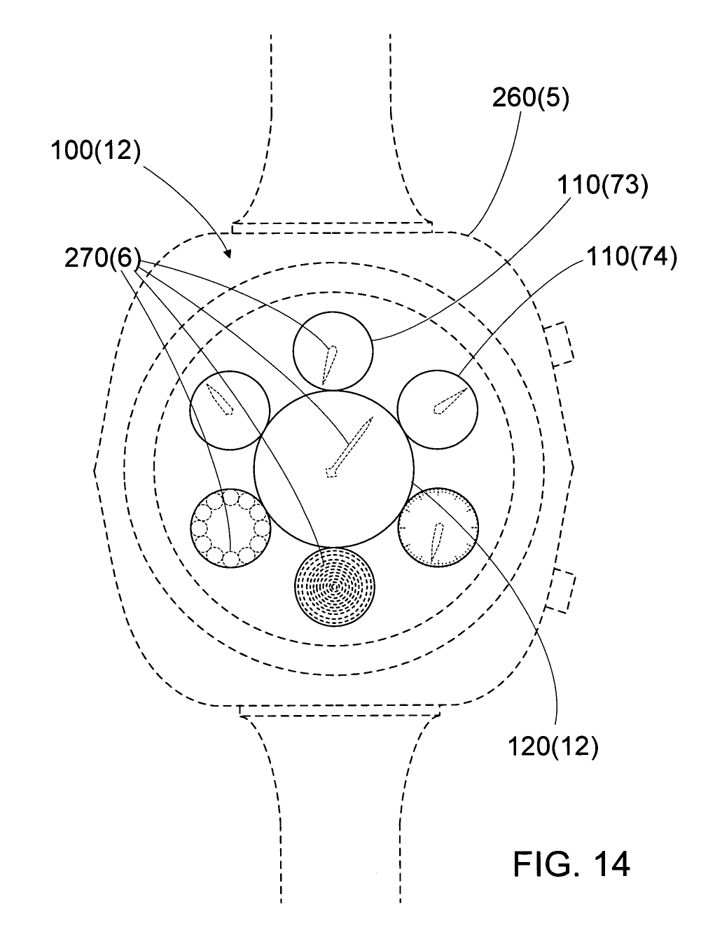

FIG. 14 illustrates one watch 260(5) with a clock display 100(12) including circular timing elements 110(73)-110(78) and 120(12). Clock display 100(12) may also include other elements 270(6) which may be, for example, hands, rings, numerals and/or other circular timing elements. Elements 110(73)-110(78), 120(12) and 270(6) may be constructed with display devices (e.g., display devices 155, FIG. 3A and FIG. 3B), for example.

FIG. 15 is a schematic diagram of a system embodiment 299 that illustrates relationships among a power source 300, a clock circuit 310, a processor 320, and a user interface 330. User interface 330 is for example buttons or knobs associated with a watch with clock display 100. User interface 330 thus communicates user preferences 332 to processor 320, which acknowledges preferences 332 by providing output 322 to clock display 100. User interface 330 may further allow the user to set up display, color and light intensity preferences, and/or set or change the time displayed (see FIG. 17). Power source 300 (e.g., a battery) supplies power 302 to each of clock circuit 310, processor 320, user interface 330 and clock display 100, as shown. A clock circuit 310 (e.g., a real time clock) may generate a clock signal (e.g., clock pulses 312) that correspond to increments of time. Clock circuit 310 communicates clock pulses 312 to a processor 320; it will be appreciated that in some embodiments, clock circuit 310 and processor 320 may be integrated into a single component. In such an embodiment, processor 320 may include a display mode register 340, a display detail register 350, a time register 360 and a pattern filter 370. Processor 320 counts pulses 312 and updates current time data in time register 360 (see FIG. 16). The user may enter preferences as to the number and time units of displays as display mode data in display mode register 340; preferences as to the appearance and position of the displays as display detail data in display detail register 350 and preferences as to the current time setting to initialize current time data in time register 360. Pattern filter 370 may utilize the current time data, the display mode data and the display detail data to generate output 322 that includes signals that drive corresponding display elements of display 100. Output 322 may be a signal bus that transmits multiple signals, such as one signal to each timing element within clock display 100, or output 322 may be signals that can be decoded by clock display 100 to activate appropriate timing elements therein.

It should be apparent that processor 320 may be a microcontroller or a plurality of devices or integrated circuits (e.g., real time clock, etc.).

FIG. 16 shows a setup method 400 that a user may utilize to control the appearance, and/or initialize the current time displayed, in a clock display 100. In step 410, the user selects a program mode to indicate whether the user desires to enter any data; if not, the setup ends. If the user selects program mode, the user selects time of day entry in step 420; if time of day entry is selected, the user enters a desired time in step 425, and step 430 updates a time register (e.g., time register 360). In step 440, the user selects a display mode; if display mode is selected, the user enters desired display mode data in step 445, and step 450 updates a display mode register (e.g., display mode register 340). In step 460, the user selects display details; if display details are selected, the user identifies the display to be updated in step 465 and enters desired display detail data in step 470; and step 475 updates a display detail register (e.g., display detail register 360).

FIG. 17 shows a timing process 500 that may be utilized to generate output 322 (see FIG. 15) for a clock display 100 with circular timing elements. Process 500 is for example implemented by processor 320, FIG. 15. Step 400 is the setup method of FIG. 16. Step 510 detects a clock pulse 312 from clock circuit 310. Step 515 increments a pulse counter within time register 360. Step 520 compares the contents of the pulse counter to the number of pulses per second. If the pulse count is not equal to the number of pulses per second, process 500 returns to step 505. If the pulse count equals the number of pulses per second, step 525 resets the pulse counter and increments a seconds register within time register 360. Step 530 compares the data in the seconds register to 60. If the data in the seconds register equals 60, step 535 resets the seconds register to zero and increments a minutes register within time register 360. Step 540 compares the data in the minutes register to 60. If the data in the minutes register equals 60, step 545 resets the minutes register to zero and increments an hours register within time register 360. Step 550 compares the data in the hours register to thirteen. If the data in the hours register equals thirteen, step 555 resets the hours register to one. After the time register updates of steps 525, 535, 545 and/or 555 are complete, step 560 applies pattern filter 370 to the data in the time register to generate output (e.g., output 322) for clock display 100. That is, pattern filter 370 first uses the display mode data and display detail data (entered by a user in setup method 400) to determine how elements of clock display 400 are configured, and uses current time data in time register 360 to determine what subset of display elements to activate to display a current time. Step 565 transmits the output to clock display 100, after which process 500 returns to step 505 to repeat.

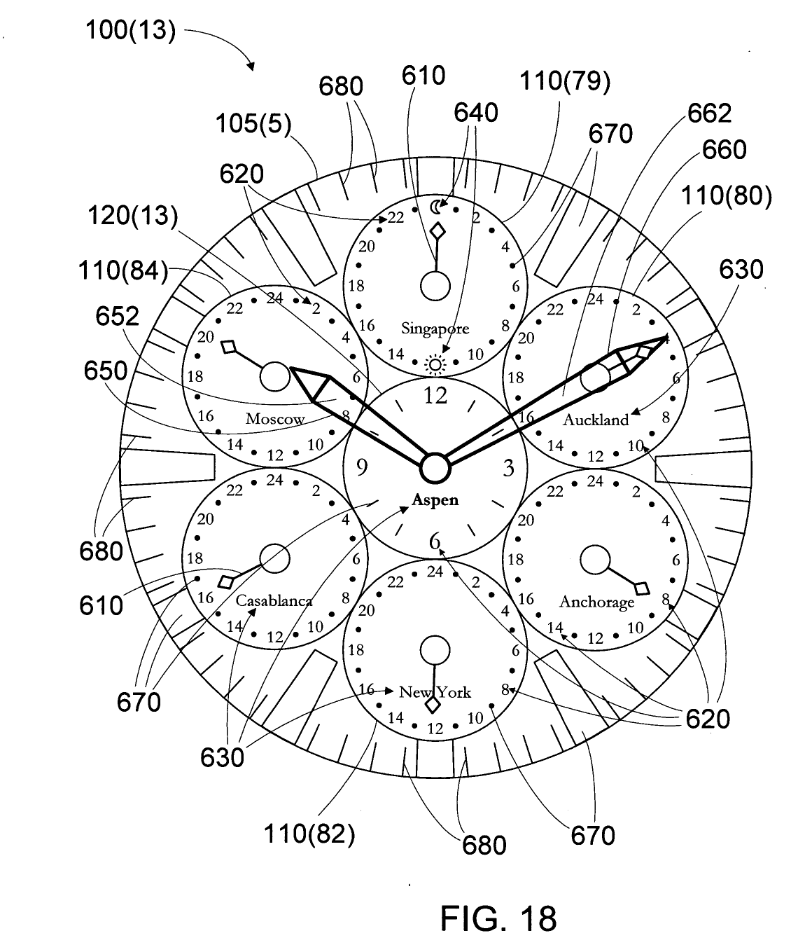

FIG. 18 shows one embodiment of a clock display 100(13) with circular timing elements 110(79)-110(84) and 120(13). Clock display 100(13) has an hour hand 650 and a minute hand 660 that indicate time in a current time zone. Hour hand 650 and minute hand 660 may include transparent portions 652 and 662 as shown, so that when the hands overlap other features of clock display 100(13), the other features remain visible. Central timing element 120(13) has optional numerals 620, optional major tick marks 670 and optional location indicia 630 (here shown as “Aspen”). A time (at Aspen) indicated by hour hand 650 and minute hand 660 in FIG. 18 is 10:10. FIG. 18 shows each of circular timing elements 110(79)-110(84) with an optional hand 610 to indicate time, optional numerals 620, major tick marks 670 and location indicia 630. Each of elements 110(79)-110(84) may be configured to show time in a different time zone. For example, in FIG. 18, element 110(79) indicates a time of just after midnight in Singapore, element 110(80) indicates a time of just after 4:00 am in Auckland, element 110(81) indicates a time of just after 8:00 am in Anchorage, element 110(82) indicates a time of just after noon in New York, element 110(83) indicates a time of just after 4:00 pm in Casablanca and element 110(84) indicates a time of just after 8:00 pm in Moscow. Clock display 100(13) is shown with an optional outer perimeter 105(5), optional minor tick marks 680 and optional day/night indicia 640.

It is appreciated that the number of time zones and specific locations illustrated in FIG. 18 are exemplary only; other embodiments may indicate time in more or fewer time zones. A central timing element may indicate time within a twelve hour span while other timing elements indicate time within a twenty-four hour span, (e.g., like timing elements 120(13) and 110(79)-110(84)), or a central element and other elements may indicate time within equal spans (e.g., each may indicate time within a twenty-four hour span), or the timing elements may represent any other combination of time spans. Numerals and tick marks may be omitted, or may be different in style and/or arrangement from numerals 620, major tick marks 670 and minor tick marks 680. The layout of each of elements 110(79)-110(84) may be different from those shown; for example, elements 110(79)-110(84) may use circular timing elements such as shown in other figures herein. Hour hand 650 and minute hand 660 may extend beyond the circumference of central timing element 120(13), as shown in FIG. 18, or may be sized so as to rotate within element 120(13).

In a manner similar to other embodiments, elements 110(79)-110(84), 120(13), hands 610, numerals 620, location indicia 630, day/night indicia 640, hour hand 650, minute hand 660, major tick marks 670 and minor tick marks 680 may be constructed with display devices (e.g., display devices 155, FIG. 3A and FIG. 3B). Alternatively, elements 110(79)-110(84), 120(13), numerals 620, location indicia 630, day/night indicia 640, major tick marks 670 and minor tick marks 680 may be formed of structure (e.g., metal, plastic, glass, ceramic) with hands 610, hour hand 650 and minute hand 660 also formed of structure and driven by a timekeeping mechanism. Provisions for changing location indicia 630, and independently resetting any of hands 610 without resetting other hands 610, to accommodate location preferences of a viewer, are also contemplated within the scope hereof.

Certain changes may be made in the clock display described herein without departing from the scope hereof. For example, a clock designer may choose other combinations of circular elements, segments thereof and locating elements; other techniques for distinguishing an activated element from one that is not activated may be implemented. A circular element that starts with a central point or spot and “fills” from that region by activating annular rings, proceeding outward from the central point or spot to a boundary of the circular element, may be used to indicate any increments of time (e.g., seconds, minutes, days of a week or months of a year, instead of hours). Alternatively, a circular element may begin an increment of time as “filled” and deactivate annular rings until it is “empty.” Additionally, the clock display described herein may be implemented in or on an object; for example, as a stand-alone clock, as a watch, as part of another object (e.g., a piece of furniture, a building, a sign or a household appliance), or within displays such as television screens or computer displays. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A clock display, comprising at least seven circular timing elements, each timing element configured to indicate time in a time zone.

2. The clock display of claim 1, one of the seven elements being a central element, the other timing elements being arranged about the central element in a regular hexagonal pattern.

3. The clock display of claim 2, wherein each of the timing elements is the same size as other timing elements.

4. The clock display of claim 3, wherein the central element is tangential to each of the other timing elements.

5. The clock display of claim 2, the central element having a first diameter, and each of the other timing elements having a second diameter that is different from the first diameter.

6. The clock display of claim 2, the central element being configured to indicate time within a twelve hour span, the other timing elements being configured to indicate time within a twenty-four hour span.

7. The clock display of claim 2, each of the other timing elements comprising location indicia.

8. The clock display of claim 1, each of the seven elements comprising location indicia.

9. The clock display of claim 1, each of the seven elements comprising an hour hand for indicating hours of time.

10. The clock display of claim 9, one of the seven elements being a central element and comprising a minute hand for indicating minutes of time.

11. The clock display of claim 10, the hour hand and the minute hand of the central element extending beyond the circumference of the central element.

12. The clock display of claim 10, at least one of the hour hand and the minute hand of the central element comprising one or more transparent portions.

13. The clock display of claim 1, further comprising a processor configured to activate display devices to display time, at least one of the circular timing elements comprising one or more of the display devices.

14. The clock display of claim 1, at least one of the seven elements comprising day and night indicia.
